(19) United States
(12) Patent Application Publication
(10) Pub. No.: US 2024/0242130 A1
(43) Pub. Date: Jul. 18, 2024

(54) INCREMENTAL CHANGE POINT DETECTION METHOD WITH DEPENDENCY CONSIDERATIONS

(71) Applicant: Hitachi, Ltd., Tokyo (JP)

(72) Inventor: Jana BACKHUS, San Jose, CA (US)

(21) Appl. No.: 18/097,172

(22) Filed: Jan. 13, 2023

(51) Int. Cl. G06N 20/20; G06Q 50/06

(52) U.S. Cl. CPC G06N 20/20; G06Q 50/06

(57) ABSTRACT

In example implementations described herein, there are systems and methods for collecting first data for a first time period and second data for a second time period regarding energy usage for, and associated characteristics of, a datacenter. The method further includes generating, based on the first data for the first time period, a first machine-trained model modeling a relationship between the energy usage and the associated characteristics. For an identified change to the relationship between the energy usage and the associated characteristics based on a first prediction error being one of greater than a first value or less than a second value, the method may include displaying an indication of the identified change; collecting, based on the identified change, third data for a third time period; and generating a second machine-trained model based on the third data.

### BACKGROUND

### Field

The present disclosure is generally directed to power efficiency change detection and analysis for data centers.

### Related Art

Data centers (DC) are heavy users of electricity and there is an ever-continuous effort to be more energy efficient. One important aspect of energy efficiency is the reduction of the amount of data center cooling power used for a certain amount of equipment power used by information technology (IT) infrastructure or devices (e.g., storages and servers). The equipment power, in some aspects, may also be referred to as IT power to distinguish the power consumed by the infrastructure providing the data maintained at the DC (e.g., the IT power) from power consumed by the facility (e.g., the DC) for other related functions such as cooling, lighting, or other power consumed in maintaining the facility. Popular metrics to express this relationship are the power usage efficiency (PUE) metric or its reciprocal Data Center infrastructure Efficiency (DCIE). The obtained metric values may change throughout a day and over a year as necessary cooling power changes or is adjusted by the DC operators with updated system settings or hotter/cooler weather. However, not all changes lead to an improvement in the overall power efficiency of the DC.

Accordingly, a power efficiency change detection and analysis tool is provided that can find changes in the power efficiency of a DC and changes in related factors as well as provide feedback to the DC operator regarding these changes.

### SUMMARY

Example implementations described herein involve an innovative method to detect and analyze power efficiency changes in a DC. In some aspects, the method may identify changes in the power efficiency of a DC and related factors. The method, in some aspects, may additionally provide (e.g., display) feedback to a DC operator about the identified changes.

Aspects of the present disclosure include a method for collecting first data for a first time period and second data for a second time period regarding energy usage for, and associated characteristics of, a datacenter. The method, in some aspects, further includes generating, based on the first data for the first time period, a first machine-trained model modeling a relationship between the energy usage and the associated characteristics. For an identified change to the relationship between the energy usage and the associated characteristics based on a difference between a first predicted energy usage for the second time period based on the first machine-trained model and a first actual energy usage for the second time period indicated in the second data being one of greater than a first value or less than a second value, the method may include displaying an indication of the identified change; collecting, based on the identified change, third data for a third time period; and generating a second machine-trained model based on the third data.

Aspects of the present disclosure include a non-transitory computer readable medium, storing instructions for execution by a processor, which can involve instructions for collecting first data for a first time period and second data for a second time period regarding energy usage for, and associated characteristics of, a datacenter. The non-transitory computer readable medium, in some aspects, may further store instructions for generating, based on the first data for the first time period, a first machine-trained model modeling a relationship between the energy usage and the associated characteristics. For an identified change to the relationship between the energy usage and the associated characteristics based on a difference between a first predicted energy usage for the second time period based on the first machine-trained model and a first actual energy usage for the second time period indicated in the second data being one of greater than a first value or less than a second value, the non-transitory computer readable medium, in some aspects, may also store instructions for displaying an indication of the identified change; collecting, based on the identified change, third data for a third time period; and generating a second machine-trained model based on the third data.

Aspects of the present disclosure include a system, which can involve means for collecting first data for a first time period and second data for a second time period regarding energy usage for, and associated characteristics of, a datacenter. The system, in some aspects, further includes means for generating, based on the first data for the first time period, a first machine-trained model modeling a relationship between the energy usage and the associated characteristics. The system may include means for, for an identified change to the relationship between the energy usage and the associated characteristics based on a difference between a first predicted energy usage for the second time period based on the first machine-trained model and a first actual energy usage for the second time period indicated in the second data being one of greater than a first value or less than a second value, displaying an indication of the identified change; collecting, based on the identified change, third data for a third time period; and generating a second machine-trained model based on the third data.

Aspects of the present disclosure include an apparatus, which can involve a processor, configured to collect first data for a first time period and second data for a second time period regarding energy usage for, and associated characteristics of, a datacenter. The processor, in some aspects, may further be configured to generate, based on the first data for the first time period, a first machine-trained model modeling a relationship between the energy usage and the associated characteristics. The processor may also be configured to, for an identified change to the relationship between the energy usage and the associated characteristics based on a difference between a first predicted energy usage for the second time period based on the first machine-trained model and a first actual energy usage for the second time period indicated in the second data being one of greater than a first value or less than a second value, display an indication of the identified change; collect, based on the identified change, third data for a third time period; and generate a second machine-trained model based on the third data.

### BRIEF DESCRIPTION OF DRAWINGS

FIG. 1 illustrates a first graph of a PUE as a function of an OAT and a second graph of cooling power usage as a function of IT power usage in accordance with some aspects of the disclosure.

FIG. 2 is a set of diagrams illustrating a PUE metric over time for two different time periods that may lead to incorrectly identified changes to a PUE metric.

FIG. 3 includes a diagram illustrating a PUE metric over time undergoing changes to the PUE.

FIG. 4 is a diagram illustrating a set of components of a system for implementing a change detection method in accordance with some aspects of the disclosure.

FIG. 5 illustrates data (and associated data structures) that may be stored by one or more of an internal data storage or external data storage of FIG. 4.

FIG. 6 is a flow diagram illustrating operations associated with an incremental change point detection with dependency modeling system in accordance with some aspects of the disclosure.

FIG. 7 is a flow diagram illustrating a set of operations associated with data preparation and data handling in accordance with some aspects of the disclosure.

FIG. 8 is a diagram illustrating a set of windows at a set of steps (or times) for two approaches to window generation for training and testing.

FIG. 9 is a diagram illustrating the use of a set of test windows (including a first validation window and a second change detection window) in accordance with some aspects of the disclosure.

FIG. 10 is a diagram illustrating an example user interface for configuring a change detection operation and for displaying the results of the change detection in accordance with some aspects of the disclosure.

FIG. 11 is a flow diagram illustrating a method in accordance with some aspects of the disclosure.

FIG. 12 is a flow diagram illustrating a method in accordance with some aspects of the disclosure.

FIG. 13 illustrates an example computing environment with an example computer device suitable for use in some example implementations.

### DETAILED DESCRIPTION

The following detailed description provides details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of the ordinary skills in the art practicing implementations of the present application. Selection can be conducted by a user through a user interface or other input means, or can be implemented through a desired algorithm. Example implementations as described herein can be utilized either singularly or in combination and the functionality of the example implementations can be implemented through any means according to the desired implementations.

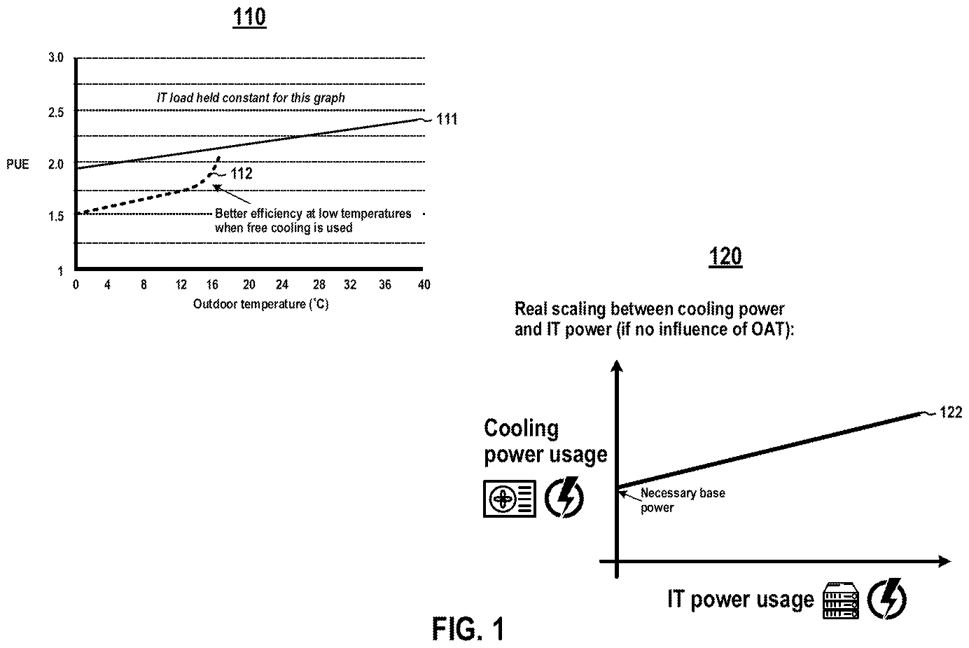

In some aspects, dependencies between a cooling power usage (or a total non-IT power) at the DC and IT power usage may be modeled to identify significant changes to a PUE. The dependencies, in some aspects, may include a dependency on an outside air temperature (OAT) as well as other factors associated with the operation of the DC resources. FIG. 1 illustrates a first graph 110 of a PUE as a function of an OAT and a second graph 120 of cooling power usage as a function of IT power usage in accordance with some aspects of the disclosure. Diagram 110 includes a first function 111 assuming no use of free cooling based on external low temperatures. Diagram 110 also incudes a second function 112 associated with a free cooling operation based on low external temperature. Diagram 120 includes a first function 122 of cooling power usage as a function of IT power usage assuming a fixed OAT (i.e., without considering the effect of the OAT). If the influence of IT power on PUE is not accounted for correctly, or appropriately, incorrect (or unnecessary) “changes” in a PUE metric may be identified in the PUE metric's time series. Accordingly, an appropriate ML model to model the relationship between cooling or total power consumption and IT power consumption in a DC for change detection is presented in this disclosure.

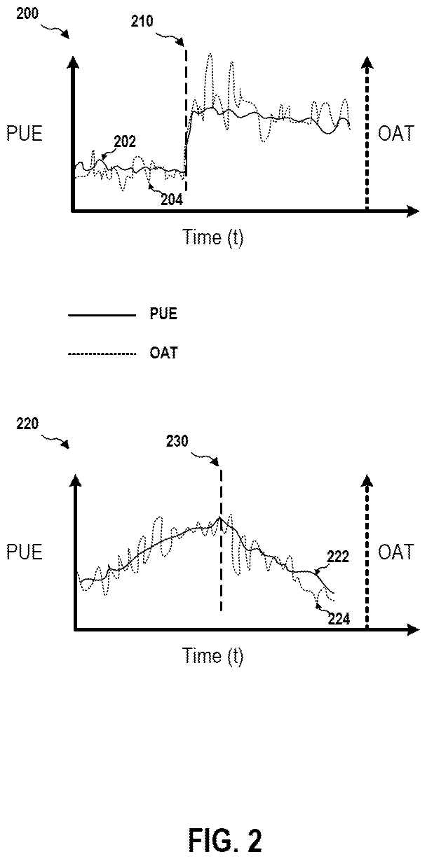

FIG. 2 is a set of diagrams 200 and 220 illustrating a PUE metric over time for two different time periods that may lead to incorrectly identified changes to a PUE metric. For example, if change points are identified based on a single time series, i.e., the PUE metric 202 or the PUE metric 222 (solid lines), then the influence of an OAT 204 or an OAT 224 (dashed lines) on PUE may not be considered correctly. Diagram 200 illustrates a graph of a PUE metric 202 over time and an OAT 204 over time during a same time period. At a time 210, the PUE metric 202 may experience a significant change (e.g., a jump) that could naively be interpreted as a meaningful change to the PUE metric 202 (or a set of factors contributing to the PUE) that should be identified to a DC administrator. However, at the time 210, the OAT 204 also experiences a similar significant change that may account for most or all of the change in the PUE metric 202. Accordingly, a ML model may be provided to account for the correlation between the OAT 204 and the PUE metric 202 to correctly identify when a change to the PUE metric 202 is due to a change in the OAT 204 (and other known factors) or when a change to the PUE metric 202 is not explainable based on known factors (such as the OAT 204).

Similarly, diagram 220 illustrates a graph of a PUE metric 222 over time and an OAT 224 over time during a same time period. At a time 230 (or throughout the time period), the PUE metric 222 may experience a significant change (e.g., a change in a trajectory, or a steady increase and/or decrease) that could naively be interpreted as a meaningful change to the PUE metric 222 (or a set of factors contributing to the PUE) that should be identified to a DC administrator. However, at the time 230 (or throughout the time period), the OAT 224 also experiences a similar change that may account for most, or all, of the change in the PUE metric 222. Accordingly, a ML model may be provided to account for the correlation between the OAT 224 and the PUE metric 222 to correctly identify when a change to the PUE metric 222 is due to a change in the OAT 224 (and other known factors) or when a change to the PUE metric 222 is not explainable based on known factors (such as the OAT 224).

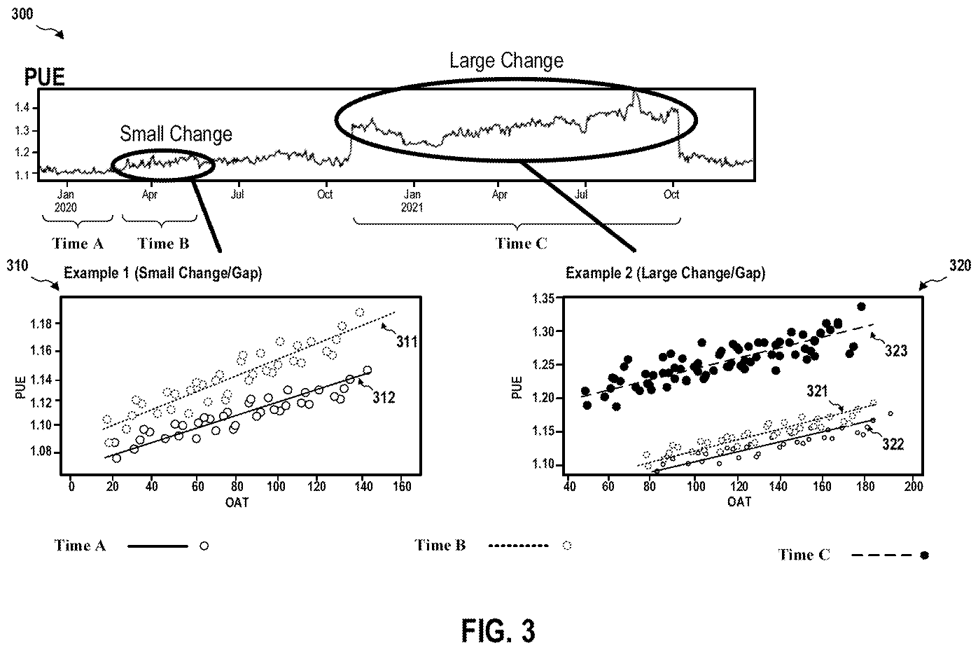

In order to find significant changes in the power efficiency of the DC, a model may be trained that considers the dependency of PUE on OAT. In some aspects, the model may approximate a linear function of OAT such that a first set of PUE values that is close to a first linear function of OAT may be considered to come from a first distribution of PUE values (e.g., a set of PUE values based on a first underlying set of conditions related to PUE). Similarly, a second set of PUE values that is close to a second linear function of OAT may be considered to come from a second distribution of PUE values (e.g., a set of PUE values based on a second underlying set of conditions related to PUE) based on the difference between the first and second linear functions of OAT, the model may identify a change to the underlying set of conditions related to the PUE for display and/or presentation to a DC administrator. FIG. 3 includes a diagram 300 illustrating a PUE metric over time undergoing changes to the PUE (e.g., based on a change to underlying factors). FIG. 3 further includes a first diagram 310 and a second diagram 320 illustrating a relationship between PUE and OAT during different time periods. Diagram 310 illustrates that during a first time period (e.g., time period A) a PUE may generally be related to an OAT with a first linear relationship (e.g., associated with trend line 312) while during a second time period (e.g., time period B) the PUE may generally be related to the OAT with a second linear relationship (e.g., associated with trend line 311) that is different from the first linear relationship (e.g., by a relatively small gap). Similarly, diagram 320 illustrates that during a third time period (e.g., time period C) a PUE may generally be related to the OAT with a third linear relationship (e.g., associated with trend line 323) that is different (e.g., by a relatively large gap) from the first linear relationship (e.g., associated with trend line 322 and corresponding to trend line 312) and/or the second linear relationship (e.g., associated with trend line 321 and corresponding to trend line 311). The model may identify the relatively large change between the first linear relationship and the second linear relationship (e.g., between the trend lines 322 and 323) represented in diagram 320, but not the relatively smaller change between the first linear relationship and the second linear relationship (e.g., between trend lines 312 and 311) represented in diagram 310, as significant enough for presentation to an administrator of the DC. In some aspects, the model may additionally identify the relatively smaller change between the first linear relationship and the second linear relationship (e.g., between trend lines 312 and 311) represented in diagram 310 as significant enough for presentation to an administrator of the DC, depending on a threshold configured for detecting changes to the PUE.

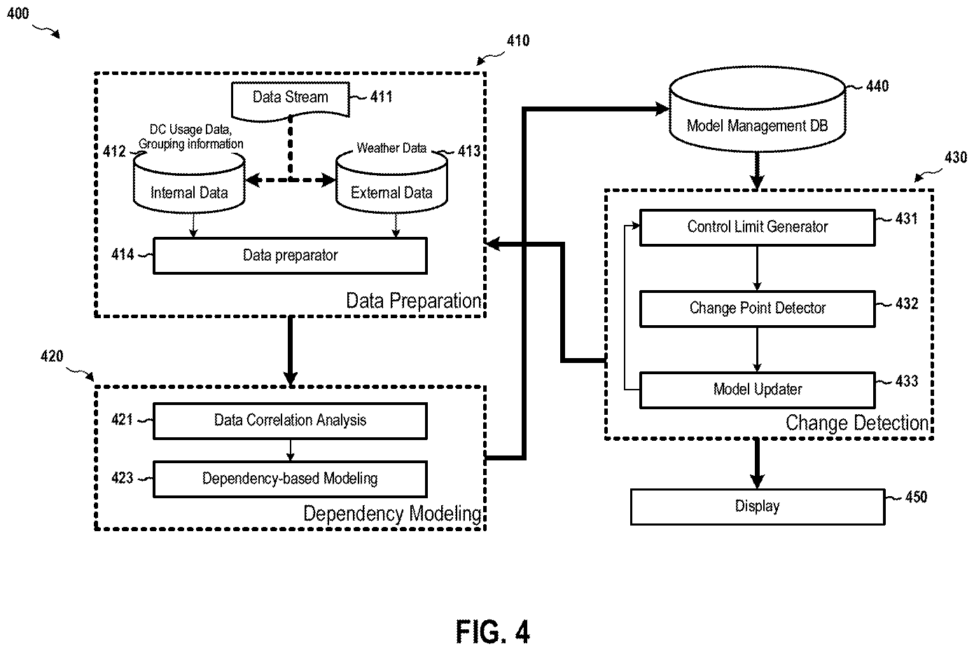

FIG. 4 is a diagram 400 illustrating a set of components of a system for implementing a change detection method in accordance with some aspects of the disclosure. At a first level of abstraction, the system may include a data preparation component or subsystem 410, a dependency modeling component or subsystem 420, and a change detection component or subsystem 430. The data preparation, dependency modeling, and change detection components or subsystems 410, 420, and 430 may interact with a model management database 440 and/or a display 450 (e.g., output interface).

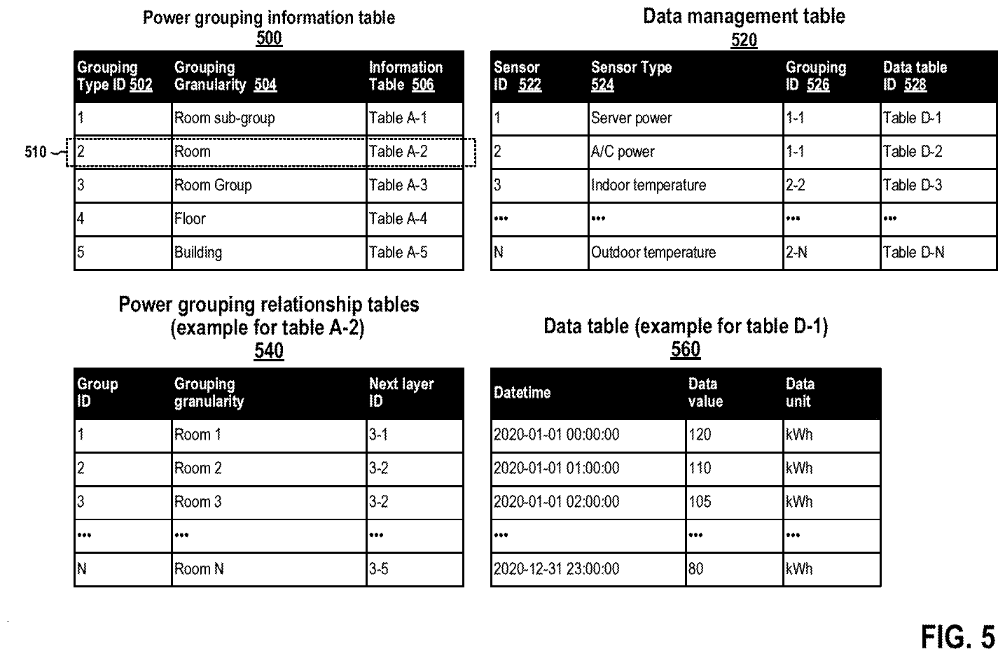

In some aspects, the data preparation component or subsystem 410 may be associated with a set of sensors, measurement devices, or other inputs that provide data in a data stream 411. The data stream 411 may be processed to store internal data (e.g., in an internal data storage 412) and external data (e.g., in an external data storage 413) for subsequent retrieval. FIG. 5 illustrates data (e.g., tables) that may be stored by one or more of the internal data storage 412 or external data storage 413 of FIG. 4. For example, power grouping information table 500 may store information regarding multiple levels of aggregation including a grouping type (or grouping level) ID 502, a grouping granularity 504, and an indication of a location of additional information associated with the level of aggregation (e.g., a pointer, index, or other identifier of another information table 506 or set of data). For example, entry 510 indicates a grouping type ID 502 of 2, a grouping granularity 504 at a room level, and an associated information table 506 of A-2 (as illustrated in power grouping relationship table 540). A data management table 520 may store information regarding a sensor (or source) ID 522, a sensor type 524, a grouping ID 526, and an associated data table ID 528 may be stored by the data preparation component or subsystem 410. For example, a first entry in the data management table 520 may refer to a data table 560 indicating a power usage at a set of times at a particular granularity (e.g., at a finest granularity that may later be aggregated for different levels of granularity).

The data preparation component or subsystem 410, in some aspects, may include a data preparator 414 that may prepare and/or group data at different levels of aggregation for different characteristics associated with the DC (e.g., aggregation based on DC room or floor, by hour, day, week, etc.). The data preparation component or subsystem 410 may receive an indication of one or more of a spatial aggregation level, a spatial extent, or a temporal aggregation level. The data preparation component or subsystem 410, in some aspects, may prepare data at the indicated spatial and temporal aggregation levels. In some aspects, preparing the data may include dividing data into windows to be processed using an incremental approach (e.g., using rolling windows). The prepared data, in some aspects, may then be provided to the dependency modeling component or subsystem 420 for a change detection operation performed by the change detection component or subsystem 430. Additional details of the data preparation are discussed below in relation to FIGS. 5-9.

The dependency modeling component or subsystem 420, in some aspects, may include a data correlation analysis component 421 and a dependency-based modeling component 423. The components of the dependency modeling component or subsystem 420 may use data provided by the data preparation component or subsystem 410 to generate and/or train a model of PUE as a function of a set of factors in the provided data. The data provided by the data preparation component or subsystem 410 may be broken up into time windows (e.g., “training windows” representing distinct time periods or overlapping and/or rolling time windows of equal length) for model training and/or generation, in some aspects. The model training may include known machine-learning algorithms and/or methods to train a machine-trained model for PUE as a function of one of more input factors (e.g., OAT, a measured IT power, temperature set points for a cooling system of the DC, etc.). The machine-trained model, in some aspects, may be a linear regression (LR) model that represents an approximately linear relationship between the OAT and the PUE.

The data provided by the data preparation component or subsystem 410 to the dependency modeling component or subsystem 420 may, in some aspects, also include a set of time windows for testing (e.g., “testing windows”). The testing windows, in some aspects, may include a most-recent time window (e.g., a change detection window) associated with a change detection operation and a second-most-recent time window (e.g., a validation window) used to determine parameters associated with the change detection operation. The testing windows may, in some aspects, be a fixed number of most recent time windows that may subsequently be used for model training and/or generation (e.g., become training windows) as new data is collected. In some aspects, the model is updated as each new time window becomes available for training until a change is detected. If a change is detected, the model may be retrained (e.g., a new machine-trained model may be generated as opposed to updating a current machine-trained model) after enough time has elapsed to collect sufficient training data (e.g., 1 day, 7 days, 1 month, etc.) to train a new model for the changed system. In some aspects, at least one recent time window (e.g., a testing window) may be used, along with the trained model, to determine a set of control limits applied by the change detection component or subsystem 430. In some aspects, using differenced data (e.g., data produced by calculating a difference between an input source data and a set of target data) instead of raw valued data may reduce the amount of training data considered sufficient to train a new model. The input source data, in some aspects, may be a data feature vector, \vec{x}, associated with a step (or time), t, and the target data may be a corresponding data feature vector, \vec{x}, associated with a previous step (or time), e.g., t− 1, t− 2, or t− n, such that the differenced data is a difference between two data feature vectors for two different time steps. In some aspects, the data feature vector, x, may include the data that is considered input and data that is considered output such that both the input to the model and the output of the model are based on differenced data. In some aspects, the reduced amount of differenced data may be sufficient for training a new model as the differenced data may model a simpler underlying relationship of different data components.

The dependency modeling component or subsystem 420, in some aspects, may provide and/or store the machine-trained model in model management database 440. The stored machine-trained model may then be used by the change detection component or subsystem 430 to detect a change to the relationship between the PUE and the set of factors considered by the machine-trained model. In some aspects, the change detection component or subsystem 430 may include a control limit generator 431 that generates threshold values used to detect changes based on a recent testing window (e.g., a validation window). The threshold values may include an upper control limit and lower control limit based on, e.g., a moving average (an exponentially weighted moving average (EWMA) or other average value) and a standard deviation (an exponentially weighted moving standard deviation (EWMSTD) or other standard deviation measure) of an error between the PUE recorded and/or calculated during the recent testing window (e.g., the validation window) and a predicted PUE produced by the machine-trained model based on the (input) data associated with the testing window (e.g., the change detection window). In some aspects, the upper control limit (UCL) may be calculated as UCL=EWMA+k+EWMSTD, and the lower control limit (LCL) may be calculated as LCL=EWMA−k*EWMSTD, where k may be a fixed value determined by an administrator based on a desired sensitivity of a related change-detection operation.

The threshold values, in some aspects, may be provided to a change point detector 432 to be used to detect a change in the underlying relationship between the PUE and the set of factors considered by the machine-trained model (e.g., to perform a change-detection operation). For example, the change point detector 432 may determine whether a recorded PUE is outside of a region defined by the threshold values (e.g., the UCL and LCL) a threshold number of times. The threshold number of times, in some aspects, may be determined by the administrator based on the desired sensitivity of the change-detection operation (and may depend on the value of k selected by the administrator).

The change point detector 432, upon detecting a change, may provide an indication to a model updater 433. The model updater 433 may indicate to the control limit generator 431 that a change has been detected to adjust the control limit generation (e.g., pause control limit generation until an updated model has been generated). The change detection component or subsystem 430 may additionally indicate to the data preparation component or subsystem 410 and/or the dependency modeling component or subsystem 420 to initiate a new model training or updating operation. The change detection component or subsystem 430 may additionally output an indication of the detected change to an administrator via a display 450 or other output interface.

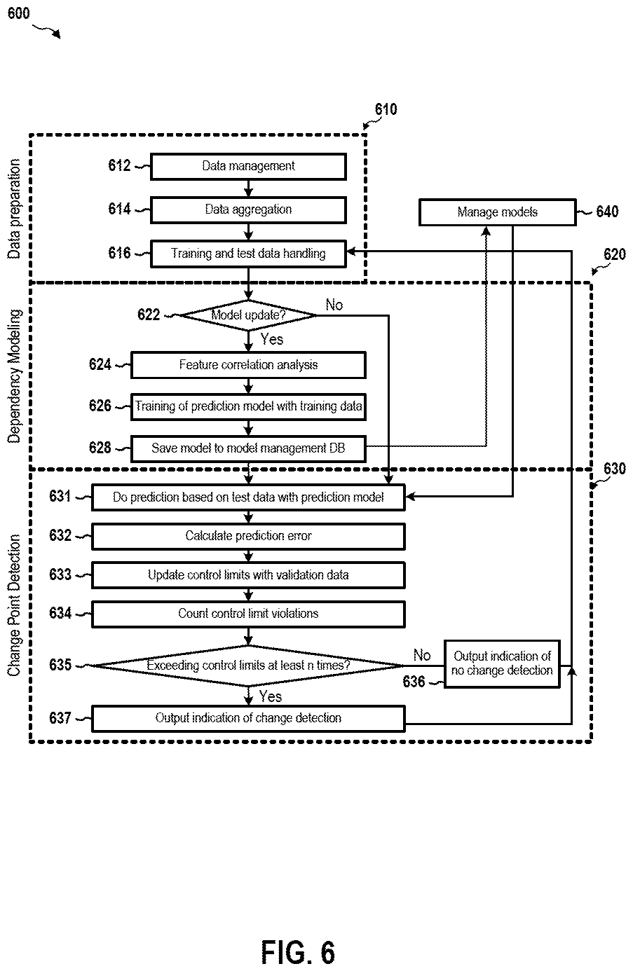

FIG. 6 is a flow diagram 600 illustrating operations associated with an incremental change point detection with dependency modeling system in accordance with some aspects of the disclosure. A set of data preparation operations 610 may include a set of data management operations at 612 for storing incoming data in one or more data structures (e.g., databases or other data structures). The one or more data structures may include different data structures for different types of data such as IT power consumption for different components of the DC, OAT, or other factors at a lowest level of aggregation (that may be aggregated to a desired level of aggregation).

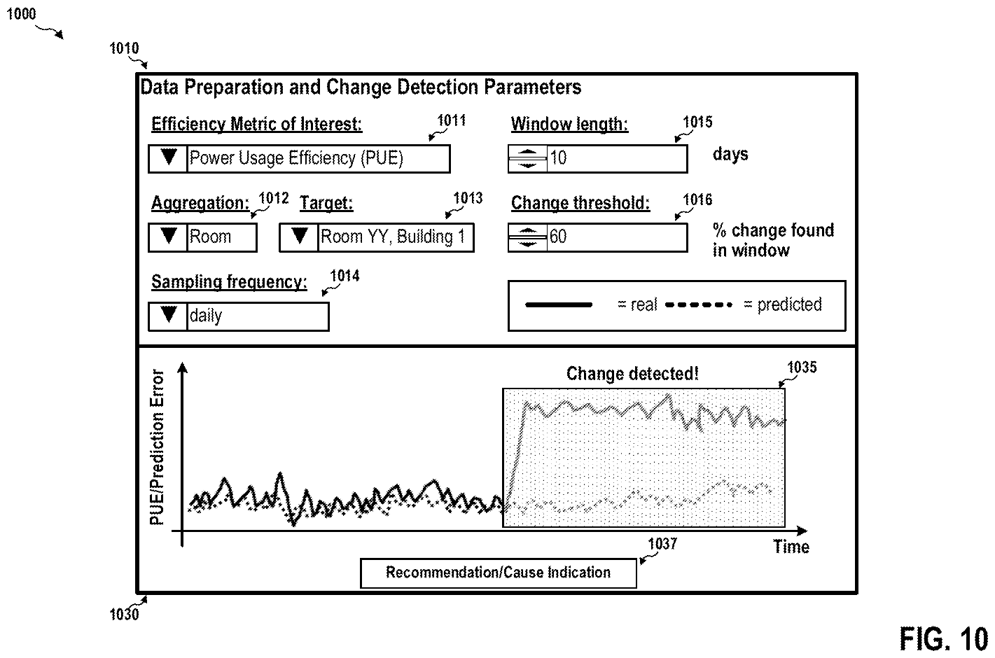

The set of data preparation operations 610 may further include a data aggregation operation at 614. The data aggregation operation at 614, in some aspects, may include a data aggregation operation to generate data at a desired level of granularity in space and in time. The data aggregation operation at 614 may, in some aspects, be based on a granularity selected by an administrator via a user interface (e.g., a user interface as illustrated in FIG. 10). In some aspects, the data aggregation operation at 614 may include a set of training and testing data handling operations at 616. At 616, a set of training and testing data handling operations may be performed and may include breaking the data generated by the data aggregation operation at 614 into training windows and testing windows.

After the set of data preparation operations 610, a set of dependency modeling operations 620 may be performed. The set of dependency modeling operations 620 may include, at 622, a determination of whether a model should be updated and/or generated. In some aspects, the determination at 622 may be based on whether a model has been generated previously (e.g., whether a model has been generated for a currently selected granularity level) or based on whether a change has been detected and a sufficient amount of time has elapsed for collecting enough data after the detected change. The determination at 622 may be based on whether a time period associated with a training window and/or testing window (or configured update frequency) has elapsed such that an additional training window is available for updating a previously generated model. If it is determined at 622 not to update the model, the system may proceed to a set of change detection operations 630 as described below.

If it is determined at 622 that the model should be updated and/or generated, the dependency modeling operations 620 may include a feature correlation analysis at 624. The feature correlation analysis at 624, in some aspects, may include calculating a correlation between data collected for different components and/or factors. The feature correlation analysis at 624, in some aspects, may also include identifying and/or selecting the data features based on the model that is being trained. For example, the feature correlation analysis at 624 may identify a set of inputs, e.g., the types of inputs (such as OAT, time, server demand, or other data) or the granularity of the inputs (such as hourly data, daily data, weekly data, or other granularity of data) and a set of outputs, e.g., types of outputs (such as total energy used, IT power, PUE, DCiE, or other data) for a particular requested model. The calculated correlations may be used, at 626, to train and/or generate a prediction model based on the set of training data (e.g., the training windows). The calculation of the correlation (e.g., at 624), in some aspects, may be part of (or included in) the model training at 626. For example, using one or more of a linear regression and/or other machine learning algorithms or operations, the model training may learn and/or identify a correlation between a metric-of-interest (e.g., a PUE or DCIE) and one or more factors in the training data (e.g., OAT, IT power, temperature control set point, or other factors). The learned and/or identified correlation may then be incorporated and/or reflected in the trained prediction model (e.g., may be related to a set of weights for one or more nodes of a machine-trained network or coefficients of a linear regression model). Once trained, the model may be saved to a model management database at 628. The system, in some aspects, may then perform, at 640, a set of model management operations to manage multiple models that may have been generated at different levels of aggregation and/or for different components (e.g., areas, rooms, or floors, etc.) of the DC. The model management, at 640, in some aspects, may include providing a desired and/or appropriate model for a set of change detection operations 630.

In some aspects, the set of change detection operations 630 may begin by predicting, at 631, based on the model generated by the set of dependency modeling operations 620 (and provided by the model management operations at 640) a PUE (or other metric-of-interest) based on input data collected for a change detection period (e.g., testing data collected during, or associated with, a change detection window in a set of testing windows). The predicted PUE may then be compared, at 632, to a measured PUE to determine a prediction error. In order to determine if the PUE is consistent with a current model, the system, in some aspects, may update, at 633, a set of control limits (e.g., as described above in relation to control limit generator 431 of FIG. 4) based on validation data (e.g., data associated with a validation window that is a previous change detection window in the set of testing windows). In some aspects, the control limits may be updated before, or in parallel with, determining a prediction error.

Based on a set of generated control limits (e.g., the control limits updated at 633), the system may, in some aspects, count a number of control limit violations at 634 (e.g., count the number of times an error exceeds an UCL or is below an LCL). As described above in relation to FIG. 4, the UCL and LCL may be configured based on a desired sensitivity of the set of change detection operations 630. The system, in some aspects, may then determine at 635 whether the count produced at 634 exceeds a threshold number, n, configured by an administrator. The number, n, in some aspects, may be configured along with the control limits to determine a sensitivity of the change point detection operation. In some aspects, the number, n, may be based on a total number of data points and/or samples in a testing window (e.g., may be configured as a percentage of data points in a window).

If the system determines at 635 that the count produced at 634 does not exceed the limit, the system may output an indication at 636 that no change has been detected and may return to the set of training and testing data handling operations at 616 to generate another set of training windows and/or testing windows (e.g., change detection windows and/or validation windows). The set of windows may be used to update a current model or to generate new control limits for a subsequent set of change detection operations 630 associated with a current test period and/or testing window. If the system determines at 635 that the count produced at 634 exceeds the limit, the system may output an indication at 637 that a change has been detected and may return to the set of training and testing data handling operations at 616 to generate another set of training windows and/or testing windows (e.g., change detection windows and/or validation windows). In some aspects, the set of training and testing data handling operations at 616 may include generating at least a minimum number of new training windows (e.g., based on data collected after the detected change) for training a new model based on the indicated change. The set of windows may be used to update a current model, to generate a new model based on the detected change, and/or to generate new control limits for a subsequent set of change detection operations 630 associated with a current test period and/or testing window. The indication of the detected change output at 637, in some aspects, may be considered at 622 to determine that the model should be updated and/or generated. The operations may be performed for a fixed number of “loops,” for a set amount of time, or until input is received indicating for the process to stop. The operations may be performed in parallel for different aggregation levels or different areas and/or components of the DC.

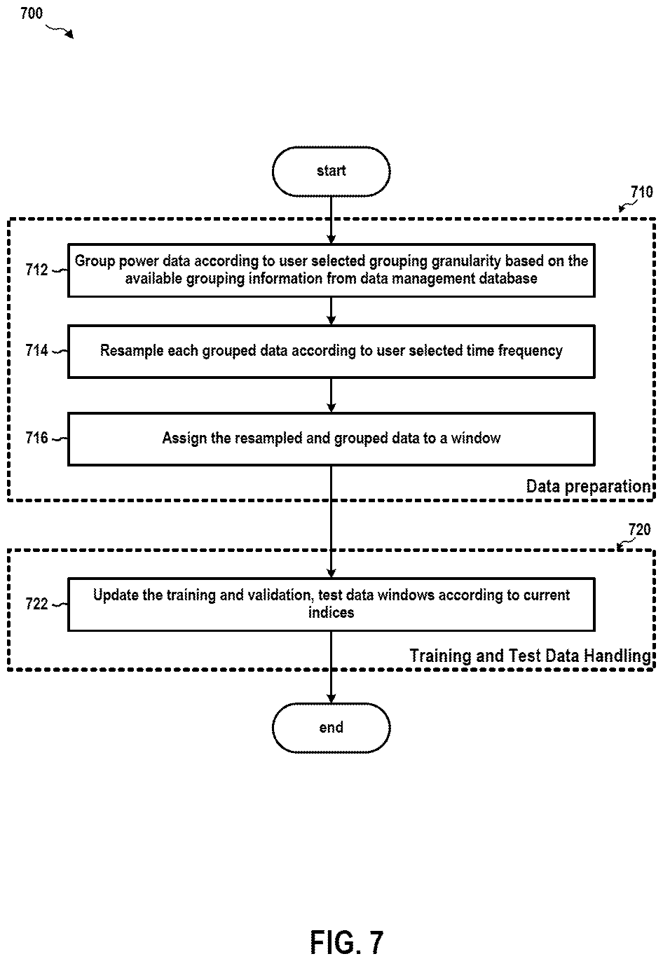

FIG. 7 is a flow diagram 700 illustrating a set of operations associated with data preparation and data handling in accordance with some aspects of the disclosure. The set of operations for data preparation may be a set of data preparation operations 710 and a set of training and test data handling operation 720 associated with a data preparator. The flow diagram 700 may be preceded by receiving an indication of a desired granularity (and/or extent) in space and/or time received via an input interface from an administrator of the DC. The set of data operations may begin at 712 by grouping power data according to the user-selected grouping granularity (e.g., the indicated spatial granularity and/or extent) based on the available grouping information from a data management database. For example, referring to FIGS. 4 and 5, the data preparation component or subsystem 410 may retrieve data (e.g., from data table 560 identified using data management table 520) from one or more of internal data storage 412 and external data storage 413 based on the power grouping identified in information table 500 and/or power grouping relationship table 540. The grouping may be aggregated at the level of the DC as a whole, a building, a floor, a room group, a room, or a rack in some aspects. The aggregation may be performed for a particular unit, or above, the level of granularity selected. For example, for a selected granularity at the floor level, the aggregation may be performed at 712 for (1) a particular floor, (2) each of a set of floors in one or more buildings, or (3) for each floor in the DC.

At 714, the data preparator may resample the grouped data (the data aggregated based on the user-selected aggregation level) based on the user-selected sampling frequency. For example, stored data points may be associated with a first, highest frequency (e.g., every second, every minute, every hour, or other frequency sufficient to identify changes with a desired characteristic time or granularity). The first, highest frequency, in some aspects, may be configured by an administrator based on a shortest time period of interest (e.g., based on a shortest time associated with a change that may be significant). For example, changes to a relationship between a PUE and IT power over time spans that are less than one day (or longer in some aspects) may be based on transient factors that an administrator may not desire to address. Accordingly, in some aspects, combined (aggregate), total, and/or average values for the grouped data may be stored for each time period representing a smallest useful time to identify changes at a meaningful and/or significant level of aggregation (e.g., a week, a day, or an hour) to minimize data storage size. The sampling may aggregate and/or average data (e.g., the grouped data) stored at a highest frequency to produce data at a lower, user-selected frequency for the level of aggregation.

At 716, the data preparator may assign the resampled and grouped data to one or more windows. In some aspects, assigning the resampled and grouped data at 716 may include generating the one or more windows based on the user-selected granularity and/or extent in space and time. The one or more windows may be a configured number of windows having a same extent in time, e.g., covering a time span of one week or one month, and extending back from the present. For example, resampled and grouped data for the past 6 months (or six weeks), in some aspects, may be broken up into six windows of one month (or one week) for training and testing. The configured number of windows, in some aspects, may be a variable number based on a time from a last detected change, a minimum number of windows for accurate training of the model, and/or a maximum number of windows to conserve processing power or to avoid overtraining the model.

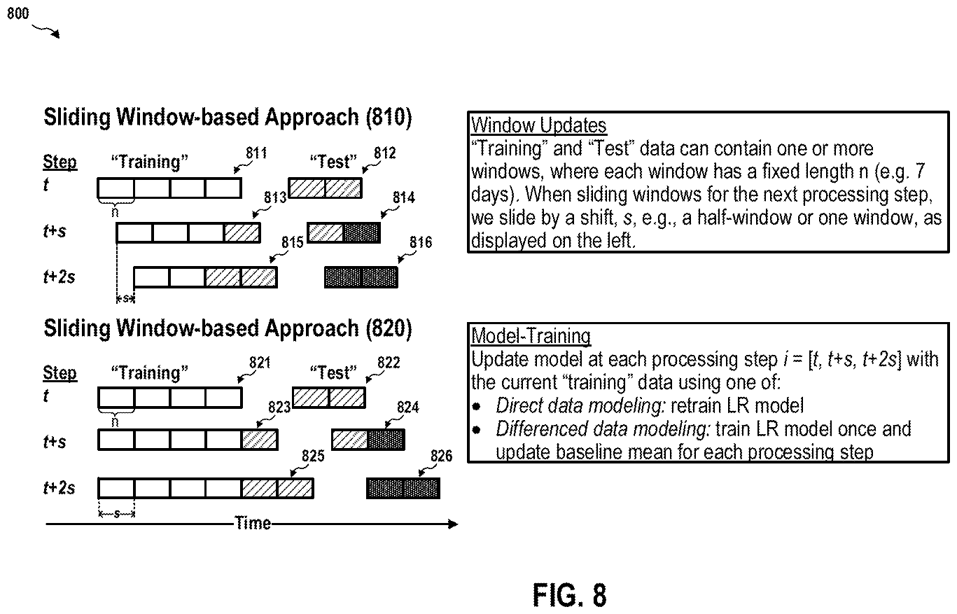

After assigning the resampled and grouped data to windows (e.g., generating the windows) at 716, the one or more windows, in some aspects, may be designated and/or identified, at 722, as one of a training window and/or a testing window (e.g., a change detection window and/or a validation window). In some aspects, the designation and/or identification at 722 may be an updated designation and/or identification of training or test windows based on a current time and/or index. FIG. 8 is a diagram 800 illustrating a set of windows at a set of steps (or times) for two approaches to window generation for training and testing. In some aspects, the operations 712 to 722 may be performed between each step (or time) to generate (and/or update the designation as) the training and test windows for a current index (or time). The operations 712 to 722 may be omitted for windows already designated and/or identified as training windows (e.g., if a maximum number of training windows has not been reached). In each approach, a first step (or time) associated with an index (or time), t, may be associated with a configured number of training windows and testing windows. As described in relation to FIG. 6, the generated training windows may be used for the set of dependency modeling operations 620 and the set of change detection operations 630, at which point, additional data may be generated in accordance with the set of data preparation operations 610 and/or the operations 712 to 722.

For subsequent steps (or times), e.g., step (or time) t+s or t+2s, one of a first sliding window approach 810, or a second sliding window approach 820 may be used in some aspects. In either of the first sliding window approach 810, or the second sliding window approach 820, the training windows may be used to train an LR model, or other machine-trained (MT) model. The training, in some aspects, may be based on direct data modeling (e.g., using raw data as measured) or differenced data modeling (e.g., using data produced by differencing raw data for at least a first training window from data for a reference time window). In some aspects, the reference time window may be one of a fixed (representative) time window or a dynamic time window such as an immediately previous time window. In each of the first sliding window approach 810 and the second sliding window approach 820, a first set of windows (e.g., windows 811, windows 813, windows 815, windows 821, windows 823, and windows 825) may be designated as training windows while a second, second set of subsequent windows (e.g., windows 812, windows 814, windows 816, windows 822, windows 824, and windows 826) may be designated as test windows (e.g., change detection and/or validation windows). In the first sliding window approach 810, the windows for each step (or time) may be shifted by a configured time, s, that may be smaller than a length, n, of a window such that at least the operations 716 and 722 are performed to update the training windows 813 and/or 815 and the testing/validation windows 814 and/or 816. For example, windows of one week (e.g., n equal to seven days) may be used with new windows being generated daily (e.g., s equal to one day) for change detection. In some aspects (as illustrated for sets of training windows 821, 823, and 825), s may be set equal to n, such that the same training windows may be reused between steps (or times) and new windows are generated for test windows based on data captured since a last step (or time).

As shown for both the first sliding window approach 810 and the second sliding window approach 820, there may be a minimum number of training windows (and an associated minimum amount of elapsed time) after a detected change before the system may be used to train a new model and use the model to detect change. For example, the system may be configured to use at least four windows (e.g., windows 811 or 821) to train a model, and use at least two windows (e.g., windows 812 and 822) to capture data for validation and/or change detection. While the first sliding window approach 810 uses a constant number of most-recent training windows, in some aspects, the second sliding window approach 820 may use an increasing number of most-recent training windows. The number of most-recent training windows used in the second sliding window approach 820 may be subject to a minimum number of training windows for accuracy in model training and/or a maximum number of training windows to conserve processing power and/or to avoid overtraining of the model. In both approaches, data associated with a test window at a first step (or time) may be associated with a training window at a subsequent step (or time).

In some aspects, the training windows may be used to update an existing model. For example, the training windows may be used to update the LR or other MT model. After a first step (or time) associated with an initial model training, the LR or MT model may, in some aspects, be updated by re-training the LR or MT model based on a current set of training windows (in either of the first sliding window approach 810 or the second sliding window approach 820). In some aspects, the LR or MT model trained during a first step (or time) may be updated (e.g., modified without a complete re-training) at each subsequent step (or time) before a change is detected based on data associated with a new training window (e.g., a window previously designated and/or identified as a testing window).

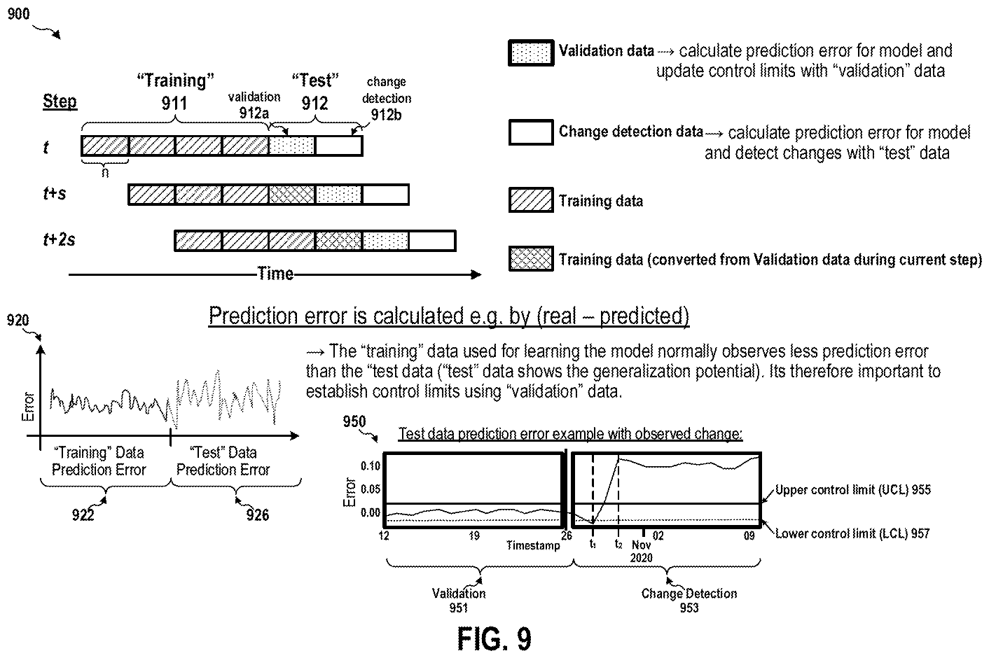

FIG. 9 is a diagram 900 illustrating the use of a set of test windows (including a first validation window and a second change detection window) in accordance with some aspects of the disclosure. Diagram 900 illustrates that a set of time windows associated with a step (or time), t, may include a first set of training windows 911 and a second set of test windows 912. The second set of test windows, in some aspects, may include a first validation window 912a and a second change detection window 912b. As discussed in relation to FIG. 8, a validation window 912a at the first time, t, may, at a later time, t+s, be used as a training window.

Diagram 920 illustrates a first prediction error 922 calculated based on data captured during a training window and a second prediction error 926 calculated based on data captured during a test window (one of a validation window or a change detection window). The prediction error (one of the first or second prediction errors 922 and 926) associated with a particular window, in some aspects, may be calculated by generating a predicted PUE using the trained model based on a set of input data (e.g., data used as inputs for the associated model) associated with the particular window and subtracting the predicted PUE from a corresponding measured PUE (e.g., PUE_{measured}−PUE_{predicted}) during the particular window (or vice versa). As illustrated, a prediction error 922 associated with a training window, in some aspects, may be (or may be expected to be) smaller (e.g., have a smaller average value) or less variable than a prediction error 926 associated with a test window. In some aspects, this difference in prediction error may be a result of having the model trained to fit the data associated with the training data.

In order to detect changes, a set of upper and lower control limits may be defined to identify changes to a relationship between cooling or total power consumption and IT power consumption in a DC. If the UCL and LCL are set based on an average prediction error and a prediction error variability associated with a training window, in some aspects, the UCL and LCL may define an area that is too restrictive and the system may produce false positives. Accordingly, in some aspects, a UCL and LCL are defined based on an average prediction error and a prediction error variability associated with a testing and/or validation window (e.g., a window that has not been used to train the model) as discussed in relation to FIG. 4. Diagram 950 illustrates a UCL 955 and LCL 957 determined based on a data associated with a validation window 951 and used to detect a change during a change detection window 953. Diagram 950 further illustrates a change detection window 953 that includes a detected change. In the example illustrated in diagram 950, the change leads to a jump in a prediction error between a first time, t₁, and a second time, t₂, such that the prediction error is above the UCL 955. In some aspects, detecting the change further includes detecting that the change persists for a threshold amount of time or is associated with a threshold number of data points (e.g., calculated prediction errors) within a window to avoid updating the model based on transient phenomena.

FIG. 10 is a diagram 1000 illustrating an example user interface for configuring a change detection operation and for displaying the results of the change detection in accordance with some aspects of the disclosure. The example user interface of diagram 1000 includes a data preparation and change detection parameter setting area 1010 and a display area 1030. The data preparation parameter setting area 1010 may include a set of input elements for defining a spatial granularity and/or extent as well as a temporal granularity and window length associated with data preparation and change detection operations. The set of input elements may include a first input element 1011 for specifying and/or setting a metric-of-interest (e.g., PUE, DCIE, etc.). A second input element 1012 and a third input element 1013, may be included in the set of input elements, in some aspects, to specify and/or set a granularity (or aggregation) level and a spatial extent, respectively. The set of input elements, in some aspects, may further include a fourth input element 1014 and fifth input element 1015 used to specify and/or set a sampling frequency and a window length for the associated data preparation and change detection operations. A sixth input element 1016, in some aspects, may be included in the set of input elements to specify and/or set a change detection sensitivity for the change detection operation. The set of input elements may include a set of drop down menus as illustrated in diagram 1000 or other types of input elements (e.g., text entry areas, radio buttons, etc.).

The display area 1030, in some aspects, may display data associated with a set of test windows. The data, in some aspects, may include one of a PUE (or other indicated metric-of-interest) or a prediction error associated with the PUE (or other indicated metric-of-interest) over time. The display area 1030, in some aspects, may include a change detection indication 1035 that a change has been detected. In some aspects, the display of the data may further include a display of an UCL and/or an LCL (as illustrated in FIG. 9). In some aspects, the display area 1030 may further include a recommendation for remedying, and/or an indication of a predicted cause for, the detected change 1037.

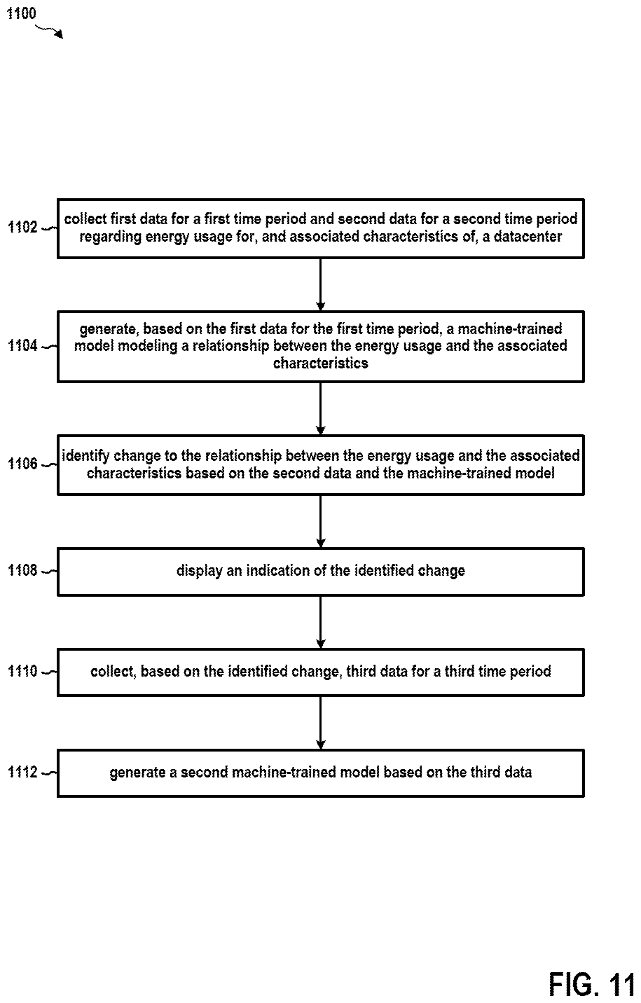

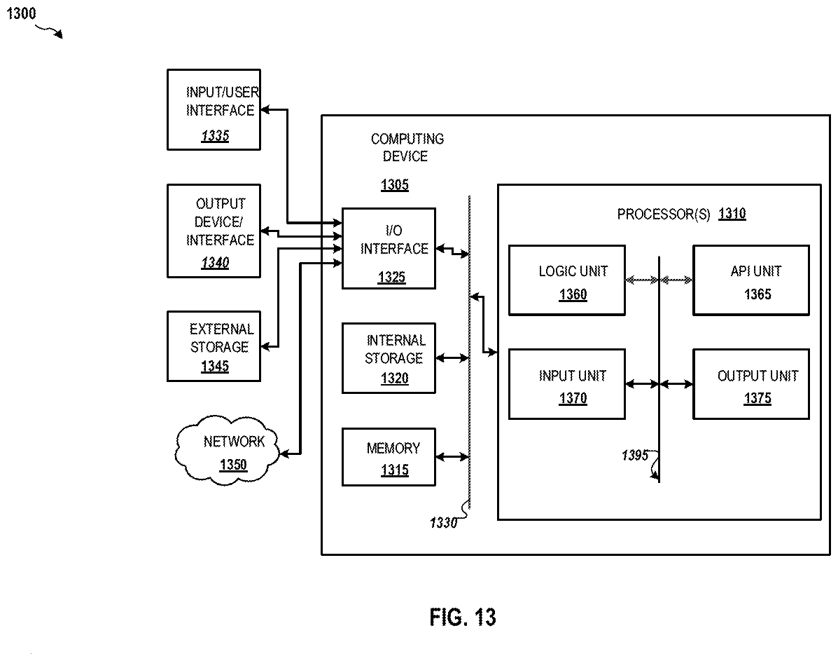

FIG. 11 is a flow diagram 1100 illustrating a method in accordance with some aspects of the disclosure. In some aspects, the method is performed by a system or apparatus (e.g., the system as described in relation to FIG. 4 or an apparatus as described below in relation to FIG. 13 below). At 1102, the system may collect first data for a first time period and second data for a second time period regarding energy usage for, and associated characteristics of, a datacenter. In some aspects, the first time period may include one or more training windows and the second time period may include a set of one or more test windows (e.g., validation windows and/or change detection windows). In some aspects, collecting the data at 1102 may include collecting fourth data for a fourth time period following the first time period and preceding the second time period (e.g., collecting data for a validation window associated with a change detection window associated with the second time period). The associated characteristics, in some aspects, may include at least an OAT and any other external data considered to be significant to a metric-of-interest (e.g., a PUE, DCIE, or other metric monitored by an administrator). In some aspects, the data regarding the energy usage may include data regarding at least a first energy usage data associated with a first power consumed by equipment providing IT functions at the datacenter (e.g., an IT power) and a second energy usage data associated with a second power consumed by the datacenter (e.g., a total power consumption).

In some aspects, the first data and/or the second data may include energy usage data at one or more levels of granularity in space and/or time. The one or more levels may include a first highest level of granularity representing a smallest unit-of-interest in space and/or time that may be aggregated to generate additional (lower) levels of granularity. For example, referring to FIG. 5, a data structure (e.g., data table 560) may store energy usage data (e.g., server power) at a granularity of one hour that may be aggregated to produce data at different (lower) levels of granularity such as daily, weekly, or monthly. In some aspects, the first data and/or the second data may include energy usage data at a plurality of levels of granularity in space and/or time. The plurality of levels of granularity in space, in some aspects, may include one or more of an IT-device level granularity (representing a highest level of granularity), a rack level granularity, a group-of-racks level granularity, a room level granularity, a group-of-rooms level granularity, a floor level granularity, a building level granularity, or a datacenter level granularity. For example, referring to FIG. 5, data associated with different levels of spatial granularity may be stored in a set of data structures (e.g., information table 500 and/or power grouping relationship table 540). The plurality of levels of granularity in time, in some aspects, may include granularity levels at one or more of seconds, minutes, hours, days, weeks, months, quarters, or years. For example, referring to FIG. 5, the system may include multiple data structures at different granularity levels (with data table 560 being an example of one such table associated with a granularity level of an hour).

At 1104, the system, in some aspects, may generate, based on the first data for the first time period, a machine-trained model modeling a relationship between the energy usage and the associated characteristics. In some aspects, the relationship between the energy usage and the associated characteristics includes a particular relationship between the second (total consumption) power, the first (IT) power, and the associated characteristics (e.g., OAT or other inputs). The particular relationship between the second power, the first power, and the associated characteristics, in some aspects, may include a function for calculating a PUE based on the first power and the associated characteristics. In some aspects, the PUE may be calculated by dividing the second power by the first power. For example, referring to FIGS. 4, 6, 9, and 10, dependency modeling component or subsystem 420 may generate a machine-trained model (e.g., a LR model) based on the set of dependency modeling operations 620 and on a set of parameters received from an administrator (e.g., via input elements 1011 to 1015).

At 1106, the system may identify a change to the relationship between the energy usage and the associated characteristics. The identification at 1106, in some aspects, may be based on a first prediction error associated with the second time period that reflects (e.g., measures, or is) a difference between a first predicted energy usage for the second time period based on the machine-trained model and a first actual energy usage for the second time period indicated in the second data being one of greater than a first value or less than a second value. In some aspects, the first value and/or the second value may be determined based on the fourth data collected for the fourth time period following the first time period and preceding the second time period. For example, the system may determine, as part of the identification at 1106, an average, and a standard deviation, of a second prediction error for the fourth time period based on a second predicted energy usage (or metric-of-interest such as PUE or DCiE) for the fourth time period predicted by the machine-trained model and a second actual energy usage (or metric-of-interest such as PUE or DCiE) for the fourth time period indicated in the fourth data. In some aspects, the second prediction error may be a difference between the second predicted energy usage and the second actual energy usage. The first value and the second value, in some aspects, may be based on the average of the second prediction error and the standard deviation of the second prediction error. In some aspects, the average of the second prediction error may be an EWMA and the standard deviation of the second prediction error may be an EWMSTD, and the first value may be the EWMA deviation plus the EWMSTD times a scaling factor and the second value is the EWMA deviation minus the EWMSTD times the scaling factor as described above in relation to FIG. 4. For example, referring to FIGS. 4, 6, 9, and 10, the change detection component or subsystem 430 (including control limit generator 431, change point detector 432, and/or model updater 433) may identify a change to the relationship based on the set of change detection operations 630 based on a set of control limits (e.g., UCL 955 and LCL 957) generated based on sensitivity set by an administrator (e.g., via input element 1016).

Based on identifying the change at 1106, the system may, at 1108, display an indication of the identified change. The display at 1108, in some aspects, may further include an indication of one or more of an identified likely cause of the change or a recommendation for remediation if the change is associated with reduced energy efficiency at the DC. For example, referring to FIG. 10, a UI may display, in display area 1030, an indication 1035 of a detected change and a recommendation for remedying, and/or an indication of a predicted cause for, the detected change 1037 based on identifying the detected change.

At 1110, the system may collect, based on the identified change, third data for a third time period. In some aspects, the third data and/or the third time period may be associated with a set of training windows after the change has been identified. The set of training windows may be a minimum number of training windows spanning a minimum amount of time as defined by an administrator (e.g., to achieve a desired level of accuracy for a machine-trained model based on the collected data). For example, referring to FIGS. 4 and 6, a data preparation component or subsystem 410 may receive an indication (e.g., the indication output at 637) from a change detection component or subsystem 430 that a change has been identified and/or detected and may collect and/or identify updated data for a new set of training windows.

After collecting the third data, the system, in some aspects, may, at 1112, generate a new (second) machine-trained model based on the third data. Generating the new (second) machine-trained model may be based on data collected after the identified and/or detected change to avoid using data associated with a previous relationship between the energy usage and the associated characteristics. In some aspects, the second data including the identified change may be used to update and/or generate the second machine-trained model along with the third data. For example, referring to FIGS. 4 and 6, the dependency modeling component or subsystem 420 may, based on the collected data for a new set of training windows update the model via the set of dependency modeling operations 620. The system may continue to monitor the PUE based on the set of parameters (e.g., granularity and extent parameters) received from an administrator until one or more of receiving an instruction to stop, receiving an updated set of parameters, or reaching a configured number of time periods from the beginning of the monitoring and/or change detection operations.

In some aspects, the fourth time period may be a previously-tested time period (e.g., a change detection window associated with a particular step preceding a step using a change detection window associated with the second time period). The system, in some aspects, may identify no change and/or an absence of a change to the relationship between the energy usage and the associated characteristics beyond a threshold. The identification may, in some aspects, be based on a second prediction error (e.g., a difference between a fourth predicted energy usage for the fourth time period based on the machine-trained model and a fourth actual energy usage for the fourth time period indicated in the fourth data) being within a range between a third value and a fourth value. The third and fourth values, in some aspects, may be based on data collected for a fifth time period preceding the fourth time period (e.g., a validation window associated with a change detection operation for the fourth time period) as the data collected for the fourth time period was used to generate the first and second values for identifying, at 1106, the change during the second time period. In some aspects, a set of threshold values (e.g., UCL and LCL values) for a current time window may be calculated based on a plurality of previous time windows (e.g., validation windows or test windows). The EWMA and EWMSTD may provide a recency bias such that more recent time periods are given more weight (e.g., based on an assumption that the more recent time periods are more relevant). In some aspects, the machine-trained model generated at 1104 may initially be generated based on the first data and may be updated based on the fifth data (or may be generated on an updated set of training data including the first data and the fifth data).

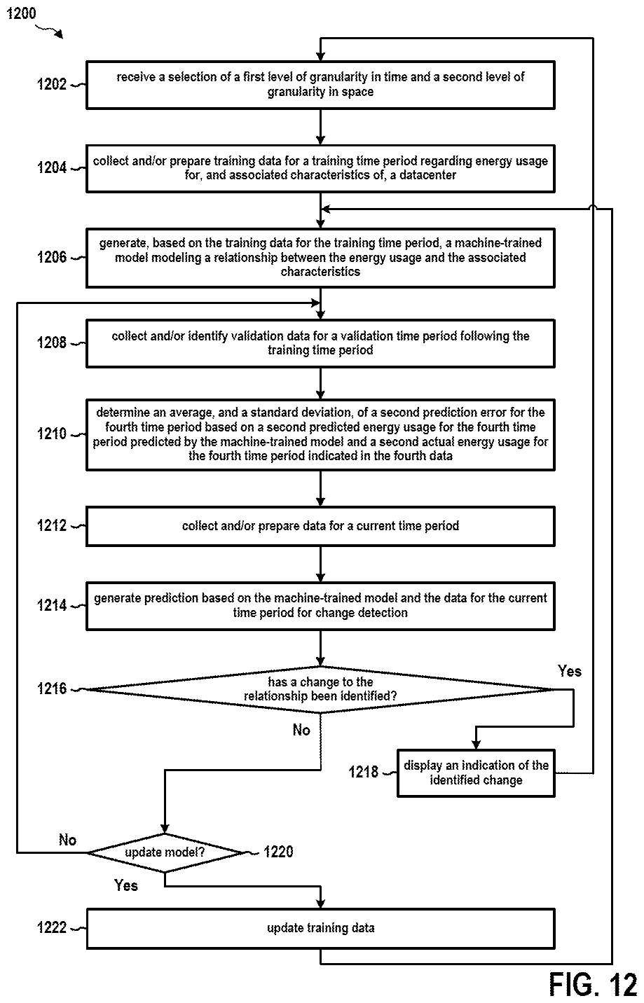

FIG. 12 is a flow diagram 1200 illustrating a method in accordance with some aspects of the disclosure. In some aspects, the method is performed by a system or apparatus (e.g., the system as described in relation to FIG. 4 or an apparatus as described below in relation to FIG. 13 below). The operations and/or steps below, for illustrative purposes may be discussed in relation to an example scenario in which a first (training) time period is followed by a second (change detection) time period during which a change is detected based on a model trained using data from at least the first time period. The second time period may be followed, in some aspects, by a third (training) time period for training a new and/or updated model based on the change detected in the second time period. The second time period may also be preceded by a fourth time period during which no change was detected and is used as a validation time period (or window) in relation to the second time period. A fifth time period that follows the first time period and precedes the fourth time period may be used, in some aspects, as a validation time period in relation to the fourth time period and may be used as part of a training period in relation to the second time period (e.g., a model trained using data from the first time period may be updated based on data from the fifth time period before being used to predict a metric-of-interest for the second time period).

At 1202 the system may receive a selection of a first level of granularity in time and a second level of granularity in space for a change detection operation. In some aspects, the system may further receive, at 1202, a spatial extent for the change detection operation. The levels of granularity in time may, in some aspects, be selected from granularity levels at one or more of seconds, minutes, hours, days, weeks, months, quarters, or years. Similarly, the levels of granularity in space may, in some aspects, be selected from one or more of an IT-device level granularity (representing a highest level of granularity), a rack level granularity, a group-of-racks level granularity, a room level granularity, a group-of-rooms level granularity, a floor level granularity, a building level granularity, or a datacenter level granularity. The spatial extent of the analysis may similarly be selected to identify an entire DC or one or more particular IT devices, racks, group of racks, rooms, group of rooms, floors, or buildings of the DC. For example, referring to FIG. 10, the system may receive a selection of parameters via one or more input elements 1011-1015.

At 1204, the system may collect and/or prepare training data for a training time period (e.g., first data for the first time period or third data for the third time period) regarding energy usage for, and associated characteristics of, a datacenter. In some aspects, the training data may include one or more training windows. The associated characteristics, in some aspects, may include at least an OAT and any other external data considered to be significant to a metric-of-interest (e.g., a PUE, DCIE, or other metric monitored by an administrator). In some aspects, the data regarding the energy usage may include data regarding at least a first energy usage data associated with a first power consumed by equipment providing IT functions at the datacenter (e.g., an IT power) and a second energy usage data associated with a second power consumed by the datacenter (e.g., a total power consumption). For example, referring to FIGS. 4-10, the data preparation component or subsystem 410 (or data preparator 414) may prepare training windows 811, 813, 815, 821, 823, 825, or 911 from information stored in data structures such as those illustrated in FIG. 5 using the operations discussed in relation to one or more of the set of data preparation operations 610 or 710 according to the spatial and temporal granularity input via one or more input elements such as input elements 1011 to 1015 of FIG. 10.

In some aspects, the training data may include energy usage data at one or more levels of granularity in space and/or time. The one or more levels may include a first highest level of granularity representing a smallest unit-of-interest in space and/or time that may be aggregated to generate additional (lower) levels of granularity. For example, referring to FIG. 5, a data structure (e.g., data table 560) may store energy usage data (e.g., server power) at a granularity of one hour that may be aggregated to produce data at different (lower) levels of granularity such as daily, weekly, or monthly. In some aspects, the training data may include energy usage data at a plurality of levels of granularity in space and/or time. The plurality of levels of granularity in space, in some aspects, may include one or more of an IT-device level granularity (representing a highest level of granularity), a rack level granularity, a group-of-racks level granularity, a room level granularity, a group-of-rooms level granularity, a floor level granularity, a building level granularity, or a datacenter level granularity. For example, referring to FIG. 5, data associated with different levels of spatial granularity may be stored in a set of data structures (e.g., information table 500 and/or power grouping relationship table 540). The plurality of levels of granularity in time, in some aspects, may include granularity levels at one or more of seconds, minutes, hours, days, weeks, months, quarters, or years. For example, referring to FIG. 5, the system may include multiple data structures at different granularity levels (with data table 560 being an example of one such table associated with a granularity level of an hour).

At 1206, the system, in some aspects, may generate (or update), based on the training data (e.g., first data for the first time period, updated training data including the first data and fifth data for the fifth time period, or third data for the third time period), a machine-trained model modeling a relationship between the energy usage and the associated characteristics. In some aspects, the relationship between the energy usage and the associated characteristics includes a particular relationship between the second (total consumption) power, the first (IT) power, and the associated characteristics (e.g., OAT or other inputs). The particular relationship between the second power, the first power, and the associated characteristics, in some aspects, may include a function for calculating a PUE (or DCIE) based on the first power and the associated characteristics. In some aspects, the PUE may be calculated by dividing the second power by the first power. For example, referring to FIGS. 4, 6, 9, and 10, dependency modeling component or subsystem 420 may generate a machine-trained model (e.g., a LR model) based on the set of dependency modeling operations 620 and on a set of parameters received from an administrator (e.g., via input elements 1011 to 1015).

At 1208, the system, in some aspect, may collect, prepare, and/or identify validation data for a validation time period. In some aspects, the validation data may be fourth data for the fourth time period when performing a change detection for the second time period. The validation in some aspects, may be the fifth data when performing a change detection for the fourth time period. In some aspects, data may be collected for a recently initiated set of change detection operations (or after identifying a change to a relationship between the energy usage and the associated characteristics). Data may be prepared and/or identified, for an ongoing (or newly initiated) set of change detection operations, from previously collected data stored in one or more data structures as discussed in relation to FIGS. 4 and 5. The validation data, in some aspects, may be at a same level of spatial and temporal granularity (and for a same spatial extent) as the training data. For example, referring to FIGS. 4-10, the data preparation component or subsystem 410 (or data preparator 414) may prepare validation data associated with a validation window 912a (or validation data associated with a test window 812, 814, 816, 822, 824, or 826) from information stored in data structures such as those illustrated in FIG. 5 using the operations discussed in relation to one or more of the set of data preparation operations 610 or 710 according to the spatial and temporal granularity input via one or more input elements such as input elements 1011 to 1015 of FIG. 10.

At 1210, the system may determine an average, and a standard deviation, of a second prediction error for the fourth time period based on a second predicted energy usage (or other metric-of-interest such as PUE or DCIE) for the fourth time period predicted by the machine-trained model and a second actual energy usage for the fourth time period indicated in the fourth data. A first control limit value (e.g., a UCL) and a second control limit value (e.g., an LCL), in some aspects, may be based on the average and the standard deviation of the second prediction error. In some aspects, the average of the second prediction error may be an EWMA and the standard deviation of the second prediction error may be an EWMSTD, and the first value may be the EWMA plus the EWMSTD times a scaling factor and the second value is the EWMA minus the EWMSTD times the scaling factor as described above in relation to FIG. 4. For example, referring to FIGS. 4, 6, 9, and 10, the change detection component or subsystem 430 (e.g., control limit generator 431) may identify, as part of the set of change detection operations 630, a set of control limits (e.g., UCL 955 and LCL 957) for identifying a change to the relationship based on the set of change detection operations 630 based on a sensitivity set by an administrator (e.g., via input element 1016).

At 1212, the system may collect, prepare, and/or identify current (e.g., change detection) data for a current time period (or step). The current time period, in some aspects, may be one of the second time period or the fourth time period. In some aspects, data may be collected for a recently initiated set of change detection operations (or after identifying a change to a relationship between the energy usage and the associated characteristics). Data may be prepared and/or identified, for an ongoing (or newly initiated) set of change detection operations (e.g., for an ongoing change detection operation associated with the second time period), from previously collected data stored in one or more data structures as discussed in relation to FIGS. 4 and 5. The current and/or change detection data, in some aspects, may be at a same level of spatial and temporal granularity (and for a same spatial extent) as the training and validation data. For example, referring to FIGS. 4-10, the data preparation component or subsystem 410 (or data preparator 414) may prepare change detection data associated with a change detection window 912b (or change detection data associated with a portion of a test window 812, 814, 816, 822, 824, or 826) from information stored in data structures such as those illustrated in FIG. 5 using the operations discussed in relation to one or more of the set of data preparation operations 610 or 710 according to the spatial and temporal granularity input via one or more input elements such as input elements 1011 to 1015 of FIG. 10.

At 1214, the system may generate a prediction based on the machine-trained model and the current (or change detection) data for the current time period for change detection. For example, a prediction may be generated based on data associated with the second or fourth time period when performing the change detection on the second or fourth time period, respectively. The prediction may be based on the data regarding the associated characteristics (e.g., an OAT) and the energy usage (e.g., the IT power) included in the current (or change detection) data to predict the metric-of-interest (e.g., PUE or DCiE) based on, or using, the machine-trained model. For example, referring to FIGS. 4-6, the dependency modeling component or subsystem 420 may generate a prediction at 631 based on input data (e.g., data stored in data table 560).

In some aspects, the system may, at 1216, determine whether it detects a change to the relationship between the energy usage and the associated characteristics based on the generated prediction. The identification at 1216, in some aspects, may be based on a prediction error that reflects, or is a measure of, a difference between a predicted energy usage for the current (e.g., second or fourth) time period based on the machine-trained model and an actual energy usage for the current (e.g., second or fourth) time period indicated in the current (e.g., second or fourth) data being one of greater than a first (control limit) value or less than a second (control limit) value. In some aspects, the identified change is further based on the difference being one of greater than the first value or less than the second value at least a threshold number of times.

If the system determines, at 1216, that a change has been detected (as for the second time period), it may proceed, at 1218, to display an indication of the identified change. The display, in some aspects, may be included in a graphical display of the prediction error over time for the current time period as one or more of an overlaid graphical element or a modification to the presentation of the prediction error (e.g., changing a color or line style). In some aspects, the display may include a text-based alert. Displaying, at 1218, the indication of the identified change may, in some aspects, include displaying an indication of a likely cause of the identified change and/or an indication of possible (or recommended) actions for mitigating the identified change (if it is a negative change such as a decreased efficiency). For example, referring to FIGS. 4, 6, and 10, the change detection component or subsystem 430, upon detecting or identifying the change, e.g., based on the set change detection operations 630 (e.g., at 635), may output (at 637) an indication of the identified change and/or cause/recommendation for mitigation (e.g., indication 1035 and/or recommendation for remedying, and/or an indication of a predicted cause for, the detected change 1037 via display area 1030).

The system may then return to collect data, at 1202, for an additional time period (e.g., the third time period) to generate a new model based on the changed relationship. The system, in some aspects, may refrain from using the machine-trained model generated based on the first data until a completion of the update (or retraining) of the machine-trained model based on the third data. For example, based on the assumption that the machine-trained model generated based on the first data is no longer accurate after the detected change, the system may not use the machine-trained model generated based on the first data and may instead wait for a new model to be generated based on the third data. The third time period, in some aspects, may include at least a threshold amount of time for collecting data to update (or generate) the machine-trained model after the identified change.

If the system determines, at 1216, that no change has been detected (e.g., that there is an absence of a change beyond a threshold amount of change) for a current time period (e.g., the fourth time period), the system may proceed to determine, at 1220, whether to update the model based on recently collected data. In some aspects, if the system determines, at 1220, not to update the model, the system may proceed to 1208 to identify data from a previous change detection time period and/or window as a validation time period and/or window for a next (now current) time period (or step). If the system determines, at 1220, to update the model, the system may proceed to update, at 1222, the training data. In some aspects, updating the training data may include including current validation data in a training data set (with or without removing an oldest training window from the training data set associated with a current or preceding step). For example, after detecting no change to the relationship during the fourth time period, the system may add the data from the fifth time period to the training data set for updating the model before using it to perform the change detection for the second time period. After updating the training data set at 1222, the system may return to 1206 to generate (or update) the machine-trained model. The method may be performed (e.g., may loop) for a fixed number of loops, for a set amount of time, or until input is received indicating for the process to stop. The operations, in some aspects, may be performed in parallel for different aggregation levels or different areas and/or components of the DC.

As discussed above, the method and/or system disclosed may provide an improvement to the training of a model for a relationship between energy usage (or related metrics-of-interest such as PUE or DCiE or other efficiency or energy usage metrics) at a DC and characteristics of the DC. The improved method may include improvements associated with the inputs considered (e.g., the types of data considered), updates to the model as additional data is collected and processed, and to the use of the model to identify changes to an underlying (or actual) relationship between the energy usage at the DC and the characteristics of the DC.

For example, as described above, the method, in some aspects, may use a limited (or reduced) amount of data for initialization and may then conduct change point detection using an incremental approach (e.g., reflected in incrementally adjusted control limits) including updates of the normal state after detection of change points. The use of limited (or reduced) data, in some aspects, may significantly improve the modeling and/or change point detection as sudden changes in the normal state of power are quite common for DCs and updates should be enabled as soon as possible. Furthermore, change point detection based on regression modeling regarding PUE based on associated characteristics such as OAT may be superior to simple change point detection that is directly conducted based on PUE only. With the disclosed machine-trained-model based system and/or method, the system and/or method may be less likely to falsely identify changes based on influencing factors (that may not be amenable to change and/or mitigation and should be ignored) as change points.

FIG. 13 illustrates an example computing environment with an example computer device suitable for use in some example implementations. Computer device 1305 in computing environment 1300 can include one or more processing units, cores, or processors 1310, memory 1315 (e.g., RAM. ROM, and/or the like), internal storage 1320 (e.g., magnetic, optical, solid-state storage, and/or organic), and/or IO interface 1325, any of which can be coupled on a communication mechanism or bus 1330 for communicating information or embedded in the computer device 1305. IO interface 1325 is also configured to receive images from cameras or provide images to projectors or displays, depending on the desired implementation.

Computer device 1305 can be communicatively coupled to input/user interface 1335 and output device/interface 1340. Either one or both of the input/user interface 1335 and output device/interface 1340 can be a wired or wireless interface and can be detachable. Input/user interface 1335 may include any device, component, sensor, or interface, physical or virtual, that can be used to provide input (e.g., buttons, touch-screen interface, keyboard, a pointing/cursor control, microphone, camera, braille, motion sensor, accelerometer, optical reader, and/or the like). Output device/interface 1340 may include a display, television, monitor, printer, speaker, braille, or the like. In some example implementations, input/user interface 1335 and output device/interface 1340 can be embedded with or physically coupled to the computer device 1305. In other example implementations, other computer devices may function as or provide the functions of input/user interface 1335 and output device/interface 1340 for a computer device 1305.

Examples of computer device 1305 may include, but are not limited to, highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, other computers, information kiosks, televisions with one or more processors embedded therein and/or coupled thereto, radios, and the like).

Computer device 1305 can be communicatively coupled (e.g., via IO interface 1325) to external storage 1345 and network 1350 for communicating with any number of networked components, devices, and systems, including one or more computer devices of the same or different configuration. Computer device 1305 or any connected computer device can be functioning as, providing services of, or referred to as a server, client, thin server, general machine, special-purpose machine, or another label.

IO interface 1325 can include but is not limited to, wired and/or wireless interfaces using any communication or IO protocols or standards (e.g., Ethernet. 1302.11x, Universal System Bus, WiMax, modem, a cellular network protocol, and the like) for communicating information to and/or from at least all the connected components, devices, and network in computing environment 1300. Network 1350 can be any network or combination of networks (e.g., the Internet, local area network, wide area network, a telephonic network, a cellular network, satellite network, and the like).

Computer device 1305 can use and/or communicate using computer-usable or computer readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks. Blu-ray disks), solid-state media (e.g., RAM, ROM, flash memory, solid-state storage), and other non-volatile storage or memory.

Computer device 1305 can be used to implement techniques, methods, applications, processes, or computer-executable instructions in some example computing environments. Computer-executable instructions can be retrieved from transitory media, and stored on and retrieved from non-transitory media. The executable instructions can originate from one or more of any programming, scripting, and machine languages (e.g., C, C++, C #, Java, Visual Basic, Python, Perl, JavaScript, and others).

Processor(s) 1310 can execute under any operating system (OS) (not shown), in a native or virtual environment. One or more applications can be deployed that include logic unit 1360, application programming interface (API) unit 1365, input unit 1370, output unit 1375, and inter-unit communication mechanism 1395 for the different units to communicate with each other, with the OS, and with other applications (not shown). The described units and elements can be varied in design, function, configuration, or implementation and are not limited to the descriptions provided. Processor(s) 1310 can be in the form of hardware processors such as central processing units (CPUs) or in a combination of hardware and software units.

In some example implementations, when information or an execution instruction is received by API unit 1365, it may be communicated to one or more other units (e.g., logic unit 1360, input unit 1370, output unit 1375). In some instances, logic unit 1360 may be configured to control the information flow among the units and direct the services provided by API unit 1365, the input unit 1370, the output unit 1375, in some example implementations described above. For example, the flow of one or more processes or implementations may be controlled by logic unit 1360 alone or in conjunction with API unit 1365. The input unit 1370 may be configured to obtain input for the calculations described in the example implementations, and the output unit 1375 may be configured to provide an output based on the calculations described in example implementations.

Processor(s) 1310 can be configured to collect first data for a first time period and second data for a second time period regarding energy usage for, and associated characteristics of, a datacenter. The processor(s) 1310 can be configured to generate, based on the first data for the first time period, a first machine-trained model modeling a relationship between the energy usage and the associated characteristics. For an identified change to the relationship between the energy usage and the associated characteristics based on a first prediction error associated with the second time period that measures a difference between a first predicted energy usage for the second time period based on the first machine-trained model and a first actual energy usage for the second time period indicated in the second data being one of greater than a first value or less than a second value, the processor(s) 1310 can be configured to display an indication of the identified change; collect, based on the identified change, third data for a third time period; and generate a second machine-trained model based on the third data. The processor(s) 1310 can be configured to receive a selection of a first level of granularity in time and a second level of granularity in space. The processor(s) 1310 can be configured to collect fourth data for a fourth time period following the first time period and preceding the second time period. The processor(s) 1310 can be configured to determine an average of a second prediction error for the fourth time period based on a second predicted energy usage for the fourth time period predicted by the first machine-trained model and a second actual energy usage for the fourth time period indicated in the fourth data. The processor(s) 1310 can be configured to determine a standard deviation of the second prediction error, wherein the first value and the second value are based on the average of the second prediction error and the standard deviation of the second prediction error. The processor(s) 1310 can be configured to collect fifth data for a fifth time period following the first time period and preceding the fourth time period. The processor(s) 1310 can be configured to determine at least an additional average or an additional standard deviation for a third prediction error based on a third predicted energy usage for the fifth time period predicted by the machine-trained model and a third actual energy usage for the fifth time period indicated in the fifth data. The processor(s) 1310 can be configured to use the machine-trained model to predict the first predicted energy usage. The processor(s) 1310 can be configured to update the machine-trained model based on the fifth data and at least a subset of the first data. The processor(s) 1310 can be configured to refrain from using the first machine-trained model until the second machine-trained model is generated based on the third data.

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In example implementations, the steps carried out require physical manipulations of tangible quantities for achieving a tangible result.

Unless specifically stated otherwise, as apparent from the discussion, it is appreciated that throughout the description, discussions utilizing terms such as “processing,” “computing,” “calculating.” “determining,” “displaying.” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer readable medium, such as a computer readable storage medium or a computer readable signal medium. A computer readable storage medium may involve tangible mediums such as, but not limited to optical disks, magnetic disks, read-only memories, random access memories, solid-state devices, and drives, or any other types of tangible or non-transitory media suitable for storing electronic information. A computer readable signal medium may include mediums such as carrier waves. The algorithms and displays presented herein are not inherently related to any particular computer or other apparatus. Computer programs can involve pure software implementations that involve instructions that perform the operations of the desired implementation.

Various general-purpose systems may be used with programs and modules in accordance with the examples herein, or it may prove convenient to construct a more specialized apparatus to perform desired method steps. In addition, the example implementations are not described with reference to any particular programming language. It will be appreciated that a variety of programming languages may be used to implement the teachings of the example implementations as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example implementations may be implemented using circuits and logic devices (hardware), while other aspects may be implemented using instructions stored on a machine-readable medium (software), which if executed by a processor, would cause the processor to perform a method to carry out implementations of the present application. Further, some example implementations of the present application may be performed solely in hardware, whereas other example implementations may be performed solely in software. Moreover, the various functions described can be performed in a single unit, or can be spread across a number of components in any number of ways. When performed by software, the methods may be executed by a processor, such as a general-purpose computer, based on instructions stored on a computer readable medium. If desired, the instructions can be stored on the medium in a compressed and/or encrypted format.

Moreover, other implementations of the present application will be apparent to those skilled in the art from consideration of the specification and practice of the teachings of the present application. Various aspects and/or components of the described example implementations may be used singly or in any combination. It is intended that the specification and example implementations be considered as examples only, with the true scope and spirit of the present application being indicated by the following claims.

What is claimed is:

1. A method comprising:
collecting first data for a first time period and second data for a second time period regarding energy usage for, and associated characteristics of, a datacenter;
generating, based on the first data for the first time period, a first machine-trained model modeling a relationship between the energy usage and the associated characteristics; and
for an identified change to the relationship between the energy usage and the associated characteristics based on a first prediction error associated with the second time period that measures a difference between a first predicted energy usage for the second time period based on the first machine-trained model and a first actual energy usage for the second time period indicated in the second data being one of greater than a first value or less than a second value:
displaying an indication of the identified change;
collecting, based on the identified change, third data for a third time period; and
generating a second machine-trained model based on the third data.

2. The method of claim 1, wherein the generating the second machine-trained model is further based on the second data.

3. The method of claim 1, further comprising:
refraining from using the first machine-trained model until the second machine-trained model is generated based on the third data, wherein the third time period comprises at least a threshold amount of time for collecting data to generate the second machine-trained model after the identified change.

4. The method of claim 1, wherein the identified change is further based on the difference being one of greater than the first value or less than the second value at least a threshold number of times.

5. The method of claim 1, wherein the associated characteristics comprise at least an outside air temperature and the energy usage comprises at least a first energy usage data associated with a first power consumed by equipment providing information technology (IT) functions at the datacenter and a second energy usage data associated with a second power consumed by the datacenter, wherein the relationship between the energy usage and the associated characteristics comprises a particular relationship between the second power, the first power, and the associated characteristics.

6. The method of claim 5, wherein the particular relationship between the second power, the first power, and the associated characteristics comprises a function for calculating a power usage effectiveness (PUE) based on the first power and the associated characteristics, wherein the PUE is calculated by dividing the second power by the first power.

7. The method of claim 5, wherein the first energy usage data and the second energy usage data comprise one or more of energy usage data at a first set of two or more levels of granularity in space or energy usage data at a second set of two or more levels of granularity in time, wherein the first set of two or more levels of granularity in space comprises one or more of an IT device-level granularity, a rack-level granularity, a group-of-racks level granularity, a room level granularity, a group-of-rooms level granularity, a floor level granularity, a building level granularity, or a datacenter level granularity, wherein the second set of two or more levels of granularity in time comprises one or more of seconds, minutes, hours, days, weeks, months, quarters, or years.

8. The method of claim 7, further comprising:
receiving a selection of a first level of granularity in time and a second level of granularity in space, wherein generating the first machine-trained model is further based on the first level of granularity in time and the second level of granularity in space.

9. The method of claim 1, further comprising:
collecting fourth data for a fourth time period following the first time period and preceding the second time period;
determining an average of a second prediction error for the fourth time period based on a second predicted energy usage for the fourth time period predicted by the first machine-trained model and a second actual energy usage for the fourth time period indicated in the fourth data; and
determining a standard deviation of the second prediction error, wherein the first value and the second value are based on the average of the second prediction error and the standard deviation of the second prediction error.

10. The method of claim 9, wherein the average of the second prediction error is an exponentially weighted moving average (EWMA) and the standard deviation of the second prediction error is an exponentially weighted moving standard deviation (EWM standard deviation), wherein the first value is the EWMA plus the EWM standard deviation and the second value is the EWMA minus the EWM standard deviation.

11. The method of claim 9, further comprising:
collecting fifth data for a fifth time period following the first time period and preceding the fourth time period;
determining at least an additional average or an additional standard deviation for a third prediction error based on a third predicted energy usage for the fifth time period predicted by the first machine-trained model and a third actual energy usage for the fifth time period indicated in the fifth data; and
for an identified absence of a change to the relationship between the energy usage and the associated characteristics beyond a threshold based on the second prediction error being within a range between a third value and a fourth value, wherein the third value and the fourth value are based on at least one of the additional average for the third prediction error or the additional standard deviation for the third prediction error:
using the first machine-trained model to predict the first predicted energy usage.

12. The method of claim 11, further comprising:
updating the first machine-trained model based on the fifth data and at least a subset of the first data, wherein the first predicted energy usage for the second time period is based on the first machine-trained model after the updating of the first machine-trained model based on the fifth data and at least the subset of the first data.

13. An apparatus comprising:
a memory; and
at least one processor coupled to the memory and, based at least in part on information stored in the memory, the at least one processor is configured to:
collect first data for a first time period and second data for a second time period regarding energy usage for, and associated characteristics of, a datacenter;
generate, based on the first data for the first time period, a first machine-trained model modeling a relationship between the energy usage and the associated characteristics; and
for an identified change to the relationship between the energy usage and the associated characteristics based on a first prediction error associated with the second time period that measures a difference between a first predicted energy usage for the second time period based on the first machine-trained model and a first actual energy usage for the second time period indicated in the second data being one of greater than a first value or less than a second value:
display an indication of the identified change;
collect, based on the identified change, third data for a third time period; and
generate a second machine-trained model based on the third data.

14. The apparatus of claim 13, wherein the at least one processor configured to generate the second machine-trained model is configured to generate the second machine-trained model based on the second data.

15. The apparatus of claim 13, wherein the at least one processor is further configured to:
refrain from using the first machine-trained model until the second machine-trained model is generated based on the third data, wherein the third time period comprises at least a threshold amount of time for collecting data to generate the second machine-trained model after the identified change.

16. The apparatus of claim 13, wherein the identified change is further based on the difference being one of greater than the first value or less than the second value at least a threshold number of times.

17. The apparatus of claim 13, wherein the associated characteristics comprise at least an outside air temperature and the energy usage comprises at least a first energy usage data associated with a first power consumed by equipment providing information technology (IT) functions at the datacenter and a second energy usage data associated with a second power consumed by the datacenter, wherein the relationship between the energy usage and the associated characteristics comprises a particular relationship between the second power, the first power, and the associated characteristics.

18. The apparatus of claim 17, wherein the first energy usage data and the second energy usage data comprise one or more of energy usage data at a first set of two or more levels of granularity in space or energy usage data at a second set of two or more levels of granularity in time, wherein the first set of two or more levels of granularity in space comprises one or more of an IT device-level granularity, a rack-level granularity, a group-of-racks level granularity, a room level granularity, a group-of-rooms level granularity, a floor level granularity, a building level granularity, or a datacenter level granularity, wherein the second set of two or more levels of granularity in time comprises one or more of seconds, minutes, hours, days, weeks, months, quarters, or years.

19. The apparatus of claim 18, wherein the at least one processor is further configured to:
receive a selection of a first level of granularity in time and a second level of granularity in space, wherein the at least one processor configured to generate the first machine-trained model is configured to generate the first machine-trained model based on the first level of granularity in time and the second level of granularity in space.

20. The apparatus of claim 13, wherein the at least one processor is further configured to:
collect fourth data for a fourth time period following the first time period and preceding the second time period;
determine an average of a second prediction error for the fourth time period based on a second predicted energy usage for the fourth time period predicted by the first machine-trained model and a second actual energy usage for the fourth time period indicated in the fourth data; and
determine a standard deviation of the second prediction error, wherein the first value and the second value are based on the average of the second prediction error and the standard deviation of the second prediction error, wherein the average of the second prediction error is an exponentially weighted moving average (EWMA) and the standard deviation of the second prediction error is an exponentially weighted moving standard deviation (EWM standard deviation), wherein the first value is the EWMA plus the EWMA standard deviation and the second value is the EWMA minus the EWM standard deviation.
